(19) United States
(12) Patent Application Publication
(10) Pub. No.: US 2017/0205010 A1
(43) Pub. Date: Jul. 20, 2017

(54) Connector Structure that is Distinguished Quickly

(71) Applicant: Kuei-Sen Pai, Changhua County (TW)

(72) Inventor: Kuei-Sen Pai, Changhua County (TW)

(21) Appl. No.: 15/001,284

(22) Filed: Jan. 20, 2016

(51) Int. Cl. F16L 37/138

(52) U.S. Cl. CPC F16L 37/138; F16L 2201/60

(57) ABSTRACT

A connector structure includes a quick connector, a first connector connected with the quick connector, and a second connector connected with the quick connector. A movable ring is mounted on the quick connector and provided with a coating layer. The first connector is provided with a coating layer. The second connector is provided with a coating layer. Thus, when the coating layer of the movable ring of the quick connector, the coating layer of the first connector and the coating layer of the second connector have the same color, the quick connector, the first connector and the second connector have the same size and specification, so that the user can quickly distinguish and select the quick connector, the first connector and the second connector of the same size and specification.

### BACKGROUND OF THE INVENTION

1. Field of the Invention

The present invention relates to a connecting device and, more particularly, to a connector structure for connecting pipes.

2. Description of the Related Art

A conventional connector structure comprises a quick connector, a first connector connected with a first end of the quick connector, and a second connector connected with a second end of the quick connector. The first connector is connected with a first pipe, and the second connector is connected with a second pipe. Thus, the first connector is connected with the quick connector, and the second connector is connected with the quick connector to construct the conventional connector structure so as to connect the first pipe and the second pipe. In practice, the quick connector, the first connector and the second connector have various sizes and specifications. However, there is no mark on the quick connector, the first connector and the second connector to indicate the sizes and specifications of the quick connector, the first connector and the second connector so that the user cannot easily distinguish the quick connector, the first connector and the second connector of the same size and specification, thereby greatly causing inconvenience in assembly of the quick connector, the first connector and the second connector.

### BRIEF SUMMARY OF THE INVENTION

The primary objective of the present invention is to provide a connector structure that is distinguished quickly.

In accordance with the present invention, there is provided a connector structure comprising a quick connector, a first connector connected with the quick connector, and a second connector connected with the quick connector. The quick connector has a front end provided with a first mounting portion and a rear end provided with a second mounting portion. A movable ring is mounted on the second mounting portion of the quick connector and is made by plastic injection molding. The movable ring has a hollow interior and defines a mounting hole and a receiving hole. The receiving hole of the movable ring has a diameter greater than that of the mounting hole. The mounting hole of the movable ring has a profile corresponding to that of the second mounting portion of the quick connector. The movable ring has an outer wall and an inner wall each provided with a coating layer. The coating layer of the movable ring has different colors corresponding to the quick connector of different sizes and specifications to facilitate identification of the quick connector. The first connector is made by plastic injection molding and has a front end provided with a fitting portion and a rear end provided with a connecting portion. The fitting portion of the first connector has a periphery provided with at least one concave section and at least one convex section. The connecting portion of the first connector is connected with the first mounting portion of the quick connector so that the first connector is combined with the quick connector. The first connector has an outer wall and an inner wall each provided with a coating layer. The coating layer of the first connector has different colors corresponding to the first connector of different sizes and specifications to facilitate identification of the first connector. The second connector is made by plastic injection molding and has a front end provided with a fitting portion and a rear end provided with a connecting portion. The fitting portion of the second connector has a periphery provided with at least one concave section and at least one convex section. The fitting portion of the second connector is connected with the second mounting portion of the quick connector so that the second connector is combined with the quick connector. The second connector has an outer wall and an inner wall each provided with a coating layer. The coating layer of the second connector has different colors corresponding to the second connector of different sizes and specifications to facilitate identification of the second connector.

In practice, when the quick connector, the first connector and the second connector have the same size and specification, the coating layer of the movable ring of the quick connector, the coating layer of the first connector and the coating layer of the second connector have the same color to facilitate quickly distinguishing of the quick connector, the first connector and the second connector of the same size and specification.

According to the primary advantage of the present invention, when the coating layer of the movable ring of the quick connector, the coating layer of the first connector and the coating layer of the second connector have the same color, the quick connector, the first connector and the second connector have the same size and specification, so that the user can quickly distinguish and select the quick connector, the first connector and the second connector of the same size and specification, thereby facilitating assembly of the quick connector, the first connector and the second connector.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is an exploded perspective view of a connector structure in accordance with the preferred embodiment of the present invention.

FIG. 2 is a cross-sectional view of a movable ring of the connector structure as shown in FIG. 1.

FIG. 3 is a perspective assembly view of the connector structure as shown in FIG. 1.

FIG. 4 is a front view of the connector structure as shown in FIG. 1.

FIG. 5 is a front exploded view of a connector structure in accordance with another preferred embodiment of the present invention.

FIG. 6 is a front view of a second connector of a connector structure in accordance with another preferred embodiment of the present invention.

FIG. 7 is a schematic operational view of the connector structure as shown in FIG. 4 in use.

FIG. 8 is a schematic operational view of the connector structure in accordance with another preferred embodiment of the present invention.

### DETAILED DESCRIPTION OF THE INVENTION

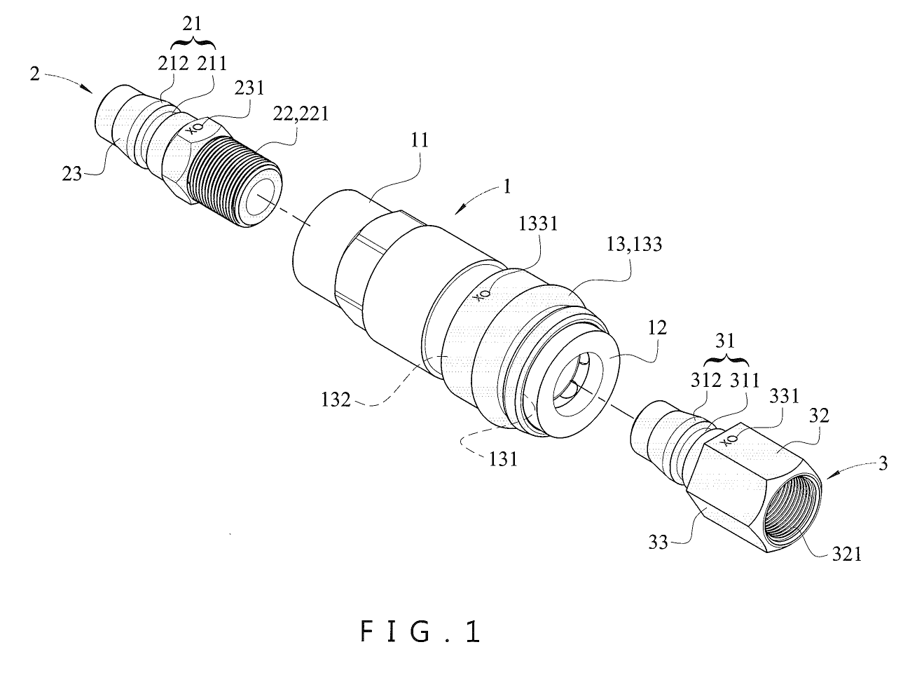

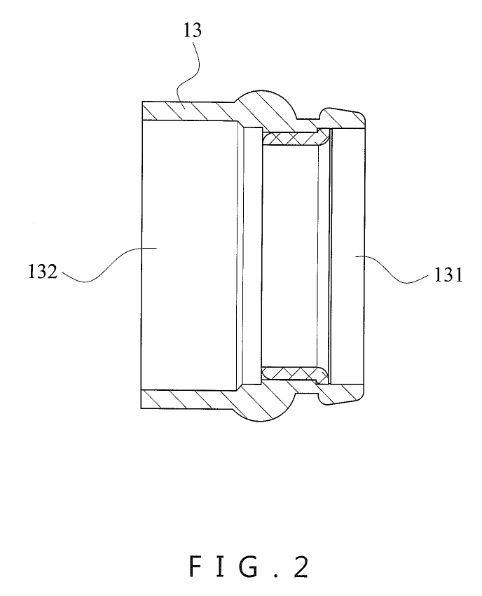

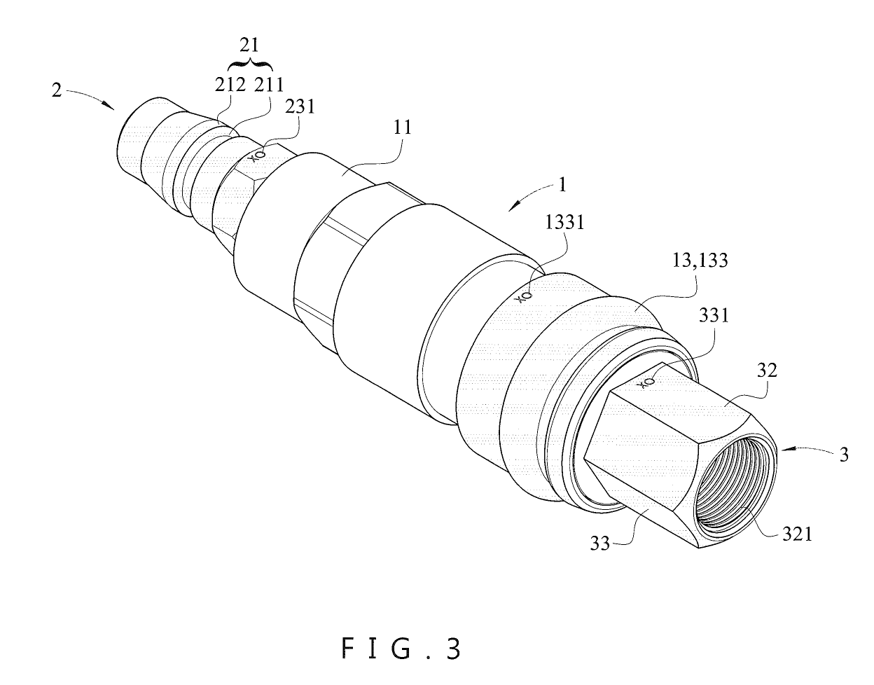

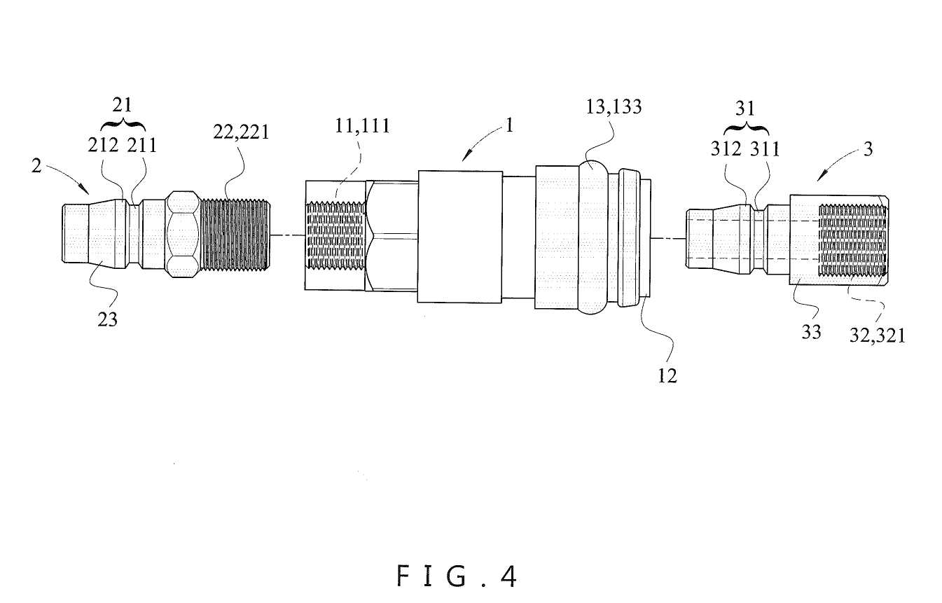

Referring to the drawings and initially to FIGS. 1-4, a connector structure in accordance with the preferred embodiment of the present invention comprises a quick connector 1, a first connector 2 connected with the quick connector 1, and a second connector 3 connected with the quick connector 1.

The quick connector 1 has a front end provided with a first mounting portion 11 and a rear end provided with a second mounting portion 12. A movable ring 13 is mounted on the second mounting portion 12 of the quick connector 1 and is made by plastic injection molding. The movable ring 13 has a hollow interior and defines a mounting hole 131 and a receiving hole 132. The mounting hole 131 and the receiving hole 132 of the movable ring 13 are used for mounting the movable ring 13 on the second mounting portion 12 of the quick connector 1. The receiving hole 132 of the movable ring 13 has a diameter greater than that of the mounting hole 131. The mounting hole 131 of the movable ring 13 has a profile corresponding to that of the second mounting portion 12 of the quick connector 1. The movable ring 13 has an outer wall and an inner wall each provided with a coating layer 133. The coating layer 133 of the movable ring 13 has different colors corresponding to the quick connector 1 of different sizes and specifications to facilitate identification of the quick connector 1.

The first connector 2 is made by plastic injection molding and has a front end provided with a fitting portion 21 and a rear end provided with a connecting portion 22. The fitting portion 21 of the first connector 2 has a periphery provided with at least one concave section 211 and at least one convex section 212. The connecting portion 22 of the first connector 2 is connected with the first mounting portion 11 of the quick connector 1 so that the first connector 2 is combined with the quick connector 1. The first connector 2 has an outer wall and an inner wall each provided with a coating layer 23. The coating layer 23 of the first connector 2 has different colors corresponding to the first connector 2 of different sizes and specifications to facilitate identification of the first connector 2.

The second connector 3 is made by plastic injection molding and has a front end provided with a fitting portion 31 and a rear end provided with a connecting portion 32. The fitting portion 31 of the second connector 3 has a periphery provided with at least one concave section 311 and at least one convex section 312. The fitting portion 31 of the second connector 3 is connected with the second mounting portion 12 of the quick connector 1 so that the second connector 3 is combined with the quick connector 1. The second connector 3 has an outer wall and an inner wall each provided with a coating layer 33. The coating layer 33 of the second connector 3 has different colors corresponding to the second connector 3 of different sizes and specifications to facilitate identification of the second connector 3.

In the preferred embodiment of the present invention, when the quick connector 1, the first connector 2 and the second connector 3 have the same size and specification, the coating layer 133 of the movable ring 13 of the quick connector 1, the coating layer 23 of the first connector 2 and the coating layer 33 of the second connector 3 have the same color to facilitate a user quickly distinguishing the quick connector 1, the first connector 2 and the second connector 3 of the same size and specification.

Preferably, the coating layer 133 of the movable ring 13 of the quick connector 1, the coating layer 23 of the first connector 2 and the coating layer 33 of the second connector 3 are formed by plastic injection molding, baking paint or transfer printing.

In the preferred embodiment of the present invention, the coating layer 133 of the movable ring 13 of the quick connector 1 is provided with a marking portion 1331 which presents a character, figure or mark, the coating layer 23 of the first connector 2 is provided with a marking portion 231 which presents a character, figure or mark, and the coating layer 33 of the second connector 3 is provided with a marking portion 331 which presents a character, figure or mark. Thus, when the quick connector 1, the first connector 2 and the second connector 3 have the same size and specification, the marking portion 1331 of the coating layer 133 of the movable ring 13 of the quick connector 1, the marking portion 231 of the coating layer 23 of the first connector 2 and the marking portion 331 of the coating layer 33 of the second connector 3 have the same status to facilitate the user quickly distinguishing the quick connector 1, the first connector 2 and the second connector 3 of the same size and specification.

In another preferred embodiment of the present invention, the first connector 2 and the second connector 3 are made of metallic material, such as copper, stainless steel, aluminum, zinc or iron.

In the preferred embodiment of the present invention, the first mounting portion 11 of the quick connector 1 is provided with an internal thread 111, and the connecting portion 22 of the first connector 2 is provided with an external thread 221 screwed into the internal thread 111 of the first mounting portion 11 of the quick connector 1. In addition, the connecting portion 32 of the second connector 3 is provided with an internal thread 321.

In operation, the user can select the quick connector 1, the first connector 2 and the second connector 3 with the same size and specification by distinguishing the coating layer 133 of the movable ring 13 of the quick connector 1, the coating layer 23 of the first connector 2 and the coating layer 33 of the second connector 3 with the same color, so that the quick connector 1, the first connector 2 and the second connector 3 with the same size and specification can be assembled easily and quickly, thereby facilitating the user assembling the quick connector 1, the first connector 2 and the second connector 3.

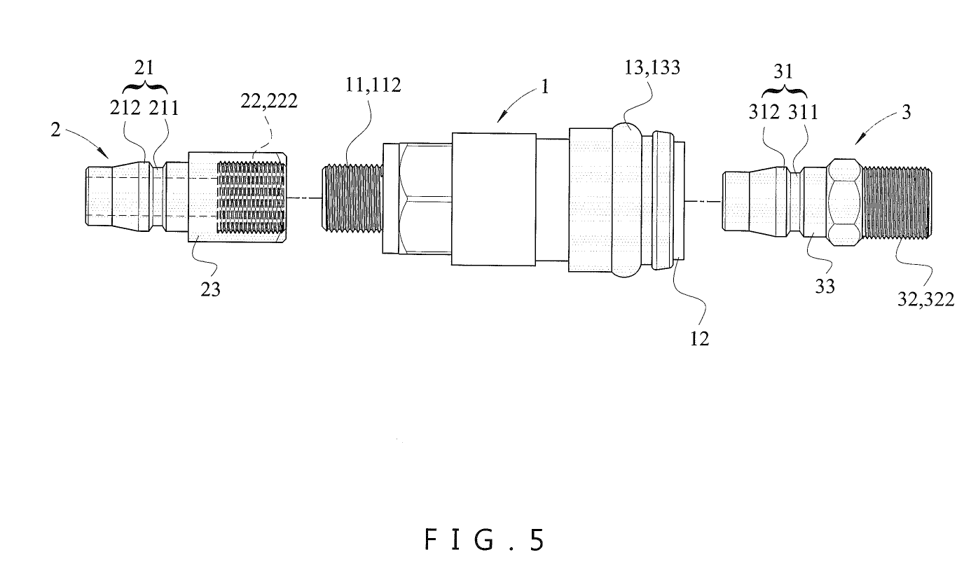

As shown in FIG. 5, the first mounting portion 11 of the quick connector 1 is provided with an external thread 112, and the connecting portion 22 of the first connector 2 is provided with an internal thread 222 screwed onto the external thread 112 of the first mounting portion 11 of the quick connector 1. In addition, the connecting portion 32 of the second connector 3 is provided with an external thread 322.

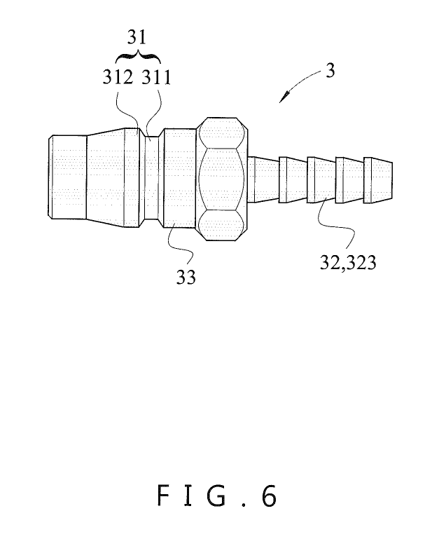

As shown in FIG. 6, the connecting portion 32 of the second connector 3 is provided with a stepped locking section 323.

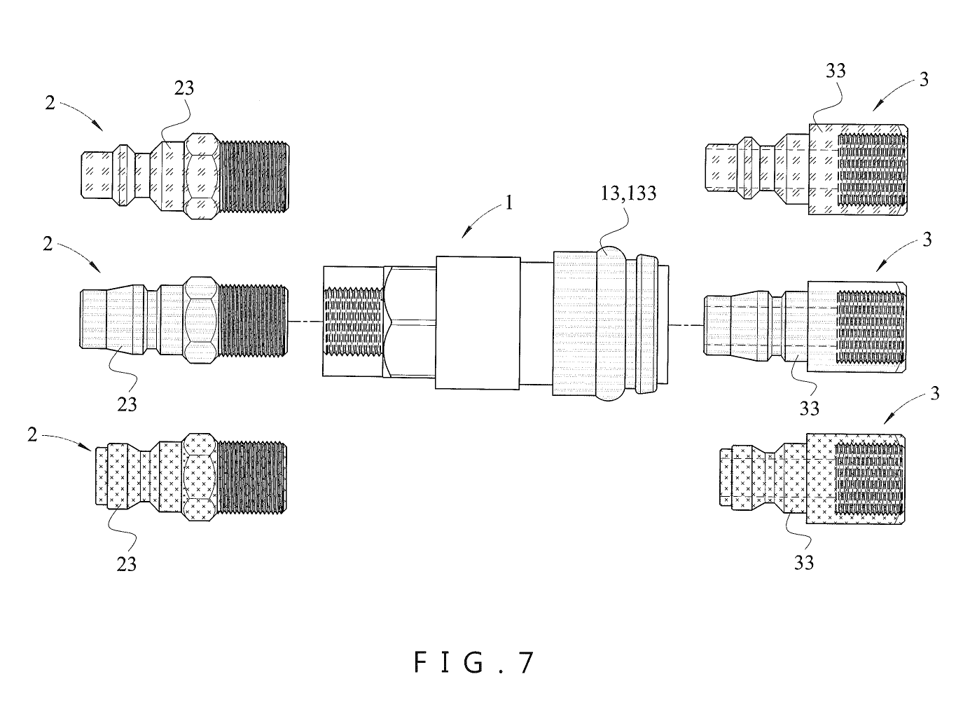

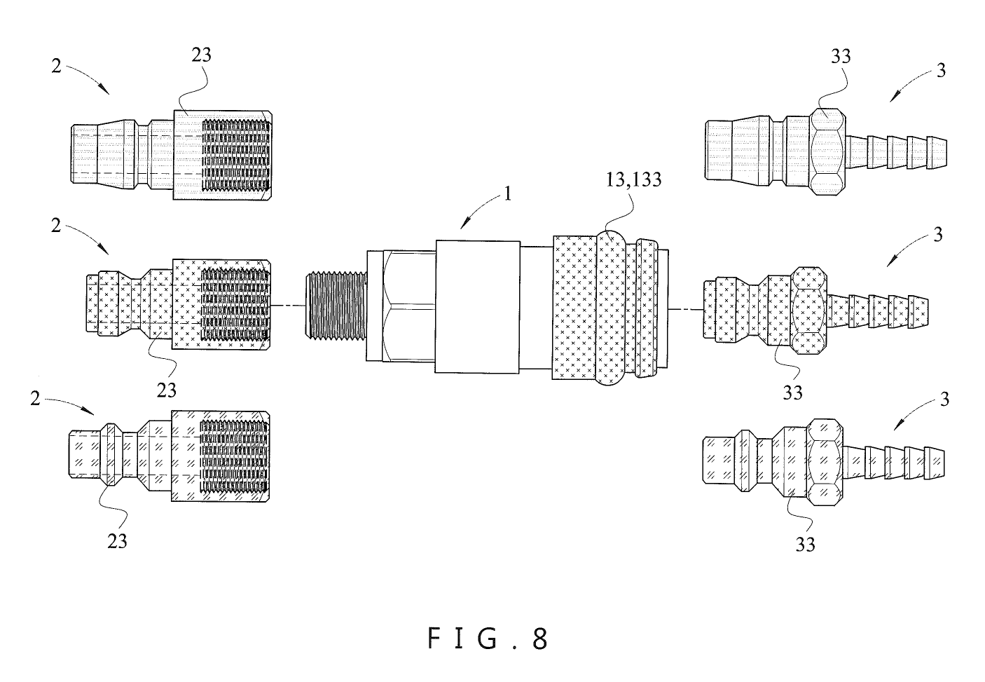

As shown in FIGS. 7 and 8, when the coating layer 133 of the movable ring 13 of the quick connector 1, the coating layer 23 of the first connector 2 and the coating layer 33 of the second connector 3 have the same color, the quick connector 1, the first connector 2 and the second connector 3 have the same size and specification, so that the user can quickly distinguish and select the quick connector 1, the first connector 2 and the second connector 3 of the same size and specification, thereby facilitating assembly of the quick connector 1, the first connector 2 and the second connector 3.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A connector structure comprising:
a quick connector;
a first connector connected with the quick connector; and
a second connector connected with the quick connector;
wherein:
the quick connector has a front end provided with a first mounting portion and a rear end provided with a second mounting portion;
a movable ring is mounted on the second mounting portion of the quick connector and is made by plastic injection molding;
the movable ring has a hollow interior and defines a mounting hole and a receiving hole;
the receiving hole of the movable ring has a diameter greater than that of the mounting hole;
the mounting hole of the movable ring has a profile corresponding to that of the second mounting portion of the quick connector;
the movable ring has an outer wall and an inner wall each provided with a coating layer;
the coating layer of the movable ring has different colors corresponding to the quick connector of different sizes and specifications to facilitate identification of the quick connector;
the first connector is made by plastic injection molding and has a front end provided with a fitting portion and a rear end provided with a connecting portion;
the fitting portion of the first connector has a periphery provided with at least one concave section and at least one convex section;
the connecting portion of the first connector is connected with the first mounting portion of the quick connector so that the first connector is combined with the quick connector;
the first connector has an outer wall and an inner wall each provided with a coating layer;
the coating layer of the first connector has different colors corresponding to the first connector of different sizes and specifications to facilitate identification of the first connector;
the second connector is made by plastic injection molding and has a front end provided with a fitting portion and a rear end provided with a connecting portion;
the fitting portion of the second connector has a periphery provided with at least one concave section and at least one convex section;
the fitting portion of the second connector is connected with the second mounting portion of the quick connector so that the second connector is combined with the quick connector;
the second connector has an outer wall and an inner wall each provided with a coating layer; and
the coating layer of the second connector has different colors corresponding to the second connector of different sizes and specifications to facilitate identification of the second connector.

2. The connector structure of claim 1, wherein when the quick connector, the first connector and the second connector have the same size and specification, the coating layer of the movable ring of the quick connector, the coating layer of the first connector and the coating layer of the second connector have the same color to facilitate quickly distinguishing of the quick connector, the first connector and the second connector of the same size and specification.

3. The connector structure of claim 1, wherein the coating layer of the movable ring of the quick connector is provided with a marking portion, the coating layer of the first connector is provided with a marking portion, and the coating layer of the second connector is provided with a marking portion.

4. The connector structure of claim 1, wherein the first mounting portion of the quick connector is provided with an internal thread, and the connecting portion of the first connector is provided with an external thread screwed into the internal thread of the first mounting portion of the quick connector.

5. The connector structure of claim 4, wherein the connecting portion of the second connector is provided with an internal thread.

6. The connector structure of claim 1, wherein the first mounting portion of the quick connector is provided with an external thread, and the connecting portion of the first connector is provided with an internal thread screwed onto the external thread of the first mounting portion of the quick connector.

7. The connector structure of claim 6, wherein the connecting portion of the second connector is provided with an external thread.

8. The connector structure of claim 1, wherein the connecting portion of the second connector is provided with a stepped locking section

9. The connector structure of claim 1, wherein the first connector and the second connector are made of metallic material.
